(19) United States
(12) Patent Application Publication
(10) Pub. No.: US 2020/0394582 A1
(43) Pub. Date: Dec. 17, 2020

(54) COMMUNICATION SYSTEM, COMMUNICATION METHOD, AND NON-TRANSITORY RECORDING MEDIUM

(71) Applicant: YOSHIHIRO OGURA, KANAGAWA (JP)

(72) Inventor: YOSHIHIRO OGURA, KANAGAWA (JP)

(73) Assignee: Ricoh Company, Ltd., Tokyo (JP)

(21) Appl. No.: 16/875,066

(22) Filed: May 15, 2020

(30) Foreign Application Priority Data
Jun. 11, 2019 (JP) 2019-108933

(51) Int. Cl. G06Q 10/06; H04L 12/58; G06Q 10/10

(52) U.S. Cl. CPC G06Q 10/06314; G06Q 10/1095; H04L 51/02; H04L 51/046

(57) ABSTRACT

A communication system, a communication method, and a non-transitory recording medium. The communication system inputs a question received from a questioner, searches for a respondent to the question, performs a first communication to answer the question, and sets a second communication separately from the first communication.

### CROSS-REFERENCE TO RELATED APPLICATIONS

This patent application is based on and claims priority pursuant to 35 U.S.C. § 119(a) to Japanese Patent Application No. 2019-108933, filed on Jun. 11, 2019 in the Japan Patent Office, the entire disclosure of which is hereby incorporated by reference herein.

### BACKGROUND

### Technical Field

The present disclosure relates to a communication system, a communication method, and a non-transitory recording medium.

### Background Art

A method of searching for a candidate who is likely to answer a submitted question appropriately has been known.

For example, a method for implementing the know-who search is known. Specifically, an information processing apparatus extracts a character string included in a mail or content on the web and searches for a knowledge attribute to which a creator of the mail and the content on the web belongs. Then, profile data of the creator is formed based on the extracted knowledge attribute. Based on the profile data formed in this way, intelligibility of knowledge specified by a person performing a know-who search is searched.

As another method for implementing a know-who search, a system for introducing a person who has knowledge in a specific field firstly accumulates task identifier (ID) related information, text, and person ID. Then, the system receives specific information from a user and performs a search. Then, the system calculates points based on the search results and rules and creates a list of persons.

In any of the conventional methods, a single set of question and answer may not satisfy a questioner, a respondent, or both. In such a case, it is desirable to additionally perform communication such as Face to Face (hereinafter referred to as “F2F”) or chat. However, in the conventional methods, it may be difficult to additionally perform communication between the questioner and the respondent.

### SUMMARY

Embodiments of the present disclosure describe a communication system, a communication method, and a non-transitory recording medium. The communication system inputs a question received from a questioner, searches for a respondent to the question, performs a first communication to answer the question, and sets a second communication separately from the first communication.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an example of a communication system;

FIG. 2 is a block diagram illustrating an example of a hardware configuration of an information processing apparatus used in the communication system;

FIG. 3 is a conceptual diagram illustrating an example of an overall process executed by the communication system;

FIG. 4 is a conceptual diagram illustrating an example of a network configuration used by the communication system;

FIG. 5 is a conceptual diagram illustrating an example of a process executed by the communication system;

FIG. 6 is a block diagram illustrating an example of a functional configuration of the communication system;

FIG. 7 is a sequence diagram illustrating a first example of an overall process executed by the communication system;

FIG. 8 is a diagram illustrating an example of an input screen for inputting a question;

FIG. 9 is a diagram illustrating an example of inputting a question;

FIG. 10 is a diagram illustrating an example of a keyword extraction result and a search result of a respondent;

FIG. 11 is a diagram illustrating an example of a transmission screen;

FIG. 12 is a sequence diagram illustrating a second example of the overall process executed by the communication system;

FIG. 13 is a sequence diagram illustrating a third example of the overall process executed by the communication system;

FIG. 14 is a diagram illustrating a screen of a comparative example;

FIG. 15 is a diagram illustrating an example of a screen including a graphic user interface (GUI) for setting a second communication; and

FIG. 16 is a diagram illustrating an example of a screen including a GUI for setting F2F communication.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

Hereinafter, a description is given of several embodiments of the present disclosure with reference to the drawings.

For example, a communication system is used in a following overall configuration.

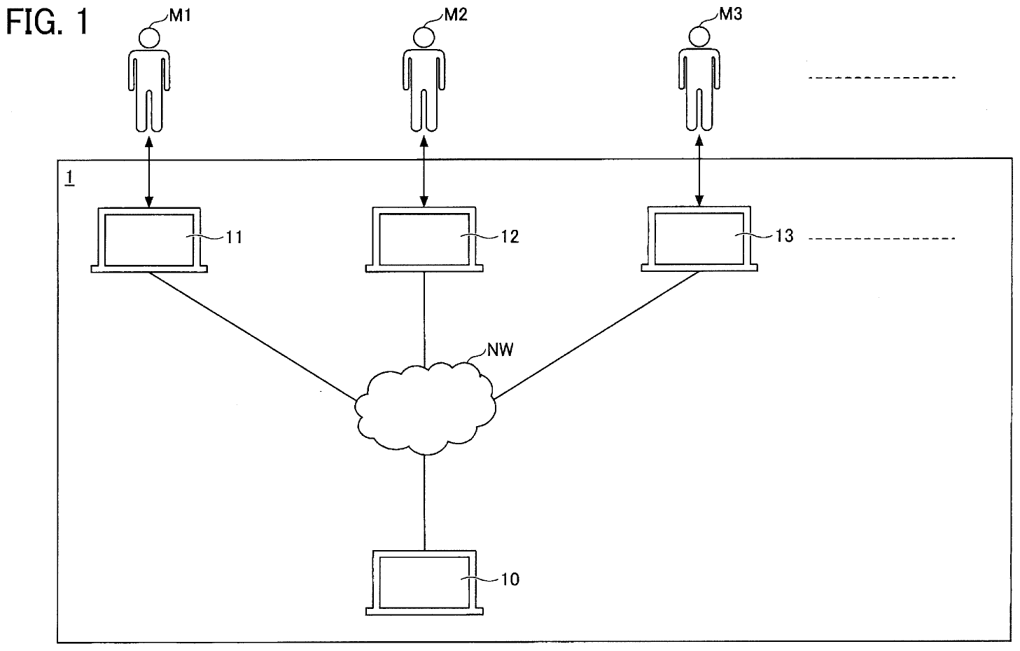

FIG. 1 is a diagram illustrating an example of the communication system 1. For example, the communication system 1 includes a first communication terminal 11 used by a person who asks a question (hereinafter, referred to as a “questioner M1”, which, in this example, one person), a second communication terminal 12 and a third communication terminal 13 used by candidates of respondents (hereinafter, referred to as “respondent M2” and “respondent M3”) respectively, and a server 10 connected to each communication terminal through a network NW.

For example, the questioner M1 inputs a question to the first communication terminal 11. Then, the server 10 receives a question transmitted from the first communication terminal 11 through the network NW. Then, the server 10 searches the respondents M2 and M3 for the question. The details of the method for searching for the respondent is described below. The respondent M2 and the respondent M3 input an answer to the question sent through the server 10 to the second communication terminal 12, the third communication terminal 13, or the like. The answer is sent to the questioner M1 through the server 10. For example, a question and an answer are made in such a procedure.

The communication system 1 implements a service called “Know Who” or “question and answer (Q and A) service”. By utilizing such services and the like, knowledge management is implemented.

A communication terminal or a server used in the communication system 1 is, for example, an information processing apparatus as described below.

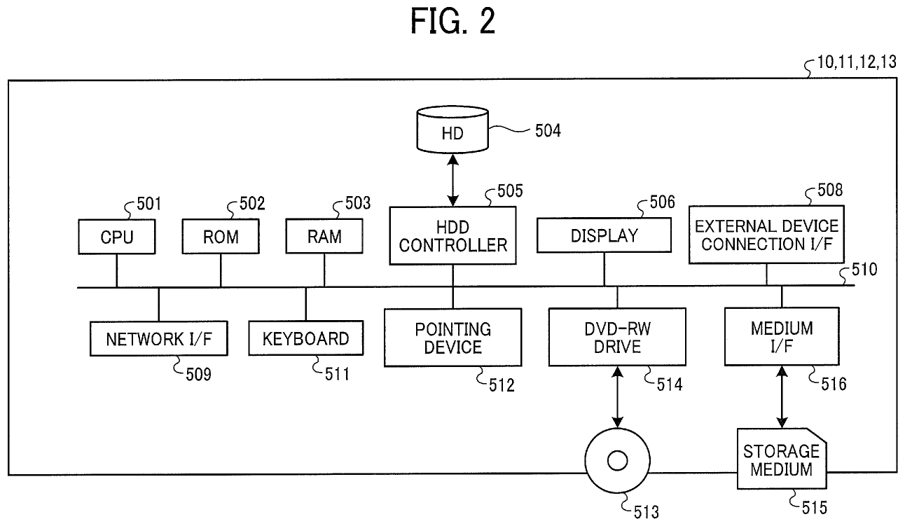

FIG. 2 is a block diagram illustrating an example of a hardware configuration of the information processing apparatus used in the communication system 1. For example, the communication terminal and the server have the same hardware configuration. Hereinafter, an example in which the hardware configuration is the same is described, and redundant description is omitted.

For example, as illustrated in FIG. 2, the server 10 is implemented by a computer, and includes a central processing unit (CPU) (hereinafter, referred to as “CPU 501”), a read-only memory (ROM) (hereinafter, referred to as “ROM 502”), a random access memory (RAM) (hereinafter referred to as “RAM 503”), a hard disk (HD) (hereinafter referred to as “HD 504”), a hard disk drive (HDD) controller (hereinafter referred to as “HDD controller 505”), display 506, an external device connection interface (I/F) (hereinafter referred to as “external device connection I/F 508”), a network I/F 509, a bus line 510, a keyboard 511, a pointing device 512, a digital versatile disk rewritable (DVD-RW) drive (hereinafter referred to as “DVD-RW drive 514”) and a medium I/F 516.

The CPU 501 is an example of a control device and an arithmetic device that control the overall operation of the server 10.

The ROM 502 stores a program such as an initial program loader (IPL) used for driving the CPU 501.

The RAM 503 is an example of a main storage device used as a work area for the CPU 501.

The HD 504 is an example of an auxiliary storage device that stores various data such as programs.

The HDD controller 505 controls reading and writing of various data from and to the HD 504 under control of the CPU 501.

The display 506 is an example of an output device that displays various information such as a cursor, a menu, a window, characters, and images.

The external device connection I/F 508 is an interface for connecting various external devices. The external device in this case is, for example, a universal serial bus (USB) memory or a printer.

The network I/F 509 is an interface for performing data communication using a communication network or the like.

The bus line 510 is an address bus, a data bus, and the like for electrically connecting each component such as the CPU 501.

The keyboard 511 is an example of an input device including a plurality of keys used to input characters, numerical values, various instructions, and the like.

The pointing device 512 is an example of an input device that allows a user to select or execute a specific instruction, select a target for processing, or move a cursor being displayed.

The DVD-RW drive 514 reads and writes various data from and to a DVD-RW 513, which is an example of a removable storage medium. The removable storage medium is not limited to the DVD-RW and may be a digital versatile disc-recordable (DVD-R) or the like.

The medium I/F 516 controls reading and writing (storing) of data from and to the storage medium 515 such as a flash memory.

Note that the hardware configuration is not limited to the illustrated configuration. The hardware configuration may further include an arithmetic device, a control device, a storage device, an input device, or an output device externally or internally. On the other hand, the hardware configuration may be a configuration without the illustrated interface or the like. Further, in the communication system, information processing apparatuses having different hardware configurations may be used.

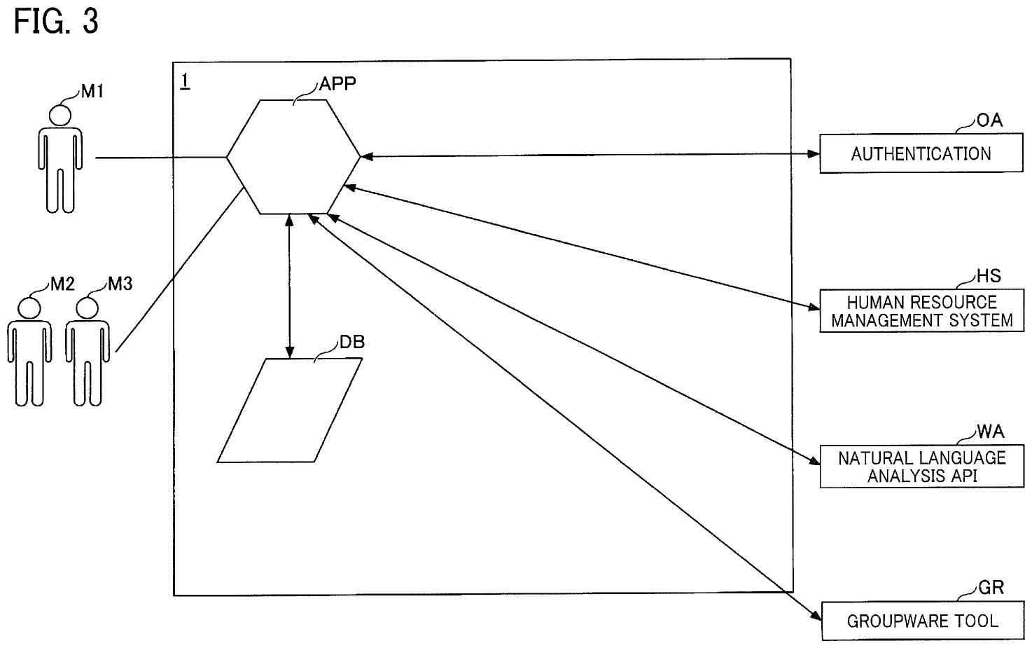

FIG. 3 is a conceptual diagram illustrating an example of an overall process executed by the communication system 1. For example, the communication system 1 provides the following services and the like by using the illustrated functions.

The questioner M1 performs various operations on the application APP and the like. For example, the questioner M1 searches for a person or the like who has specialized knowledge for a question using the application APP. That is, the questioner M1 searches for the respondents M2 and M3. Further, the questioner M1 submits a question by inputting text or the like indicating a question to the application APP. Then, the questioner M1 obtains know-how by seeing the answer from the respondent displayed by the application APP.

Further, the server 10 constructs a database DB. The database DB stores, for example, information on persons and information on keywords used in the past. When the server 10 searches the database DB, the server 10 extracts a person who can be a respondent to a question input through the application APP. Similarly, when the server 10 searches the database DB, it is desirable that the server 10 extracts a keyword or the like that is the same as or similar to the question input through the application APP.

In the keyword extraction process, a keyword is extracted from a sentence indicating a question input through the application APP.

The keyword extraction process is implemented by, for example, a natural language analysis application programming interface (API) WA or the like. Specifically, the natural language analysis processing API WA is implemented by, for example, Google (registered trademark) Cloud Natural Language API. When the sentence indicating the question is processed by the natural language analysis processing API WA in the keyword extraction processing, a keyword is output as a processing result. It is desirable that the application APP acquires the keyword extracted from the question as described above.

Note that the communication system 1 may be able to extract a keyword from a question. The communication system 1 may have a function of analyzing a sentence indicating a question and extract a keyword. In other words, the communication system 1 may have a configuration having a function such as a natural language analysis API for performing a process of extracting a keyword from a sentence such as a question or a configuration in which an external device or the like connected through a network or the like has a function of natural language analysis outside so that a result of keyword extraction can be obtained.

Furthermore, keyword extraction may not be performed. For example, the question may be in the form of inputting a keyword. In such a case, the process of extracting the keyword from the question can be omitted, and the words input as the question (that is, the state equal to the result of the keyword by the keyword extraction process, etc.) may be used as a search key or the like.

Further, the communication system 1 may cooperate with a human resource management system HS or the like as illustrated in FIG. 3. The application APP acquires personnel information such as skills from the human resource management system HS or the like. Persons having matching skills may be searched by accessing the database DB based on the human resource information.

As illustrated in FIG. 3, the questioner M1 and the like may perform the authentication OA process. Specifically, the process of the authentication OA is authentication by a so-called OAuth or the like.

Further, the communication system 1 may cooperate with a communication tool such as a groupware tool GR as illustrated in FIG. 3. The groupware tool GR is a tool or the like having a function of managing a schedule. Based on a request from the application APP or the like, the groupware tool GR sets a schedule such as a reservation of a meeting etc. or change a reservation in the schedule, in order for a target person to have F2F communication, or display the schedule in order to check and make a reservation or the like. Schedule data in which a schedule of a person who uses the communication system 1 is input in advance in the groupware tool GR. Alternatively, the groupware tool GR may have authority to access schedule data stored in the humane resource management system HS or the like.

In addition, it is desirable to be able to make reservations for equipment. That is, the groupware tool GR may make reservations and the like for facilities such as an information processing apparatus, a projector, a whiteboard, and a desk used for F2F communication.

Further, the groupware tool GR may be capable of reserving places and facilities. In order to perform F2F communication such as a meeting, it is desirable that the groupware tool GR can reserve a place such as a meeting room or a meeting space.

Note that both the place and the equipment may be reserved together.

Further, the groupware tool GR may have a function of communicating by chat, displaying a contact, transmitting and receiving a message, transmitting and receiving a voice, transmitting and receiving an image, or a combination thereof. The groupware tool GR implements mail, bulletin board, chat, video meeting, telephone, voice communication through a network, sharing of writing on an electronic whiteboard, or the like, or communication by a combination of the above. Note that the communication method may be other than the methods described above. The groupware tool GR performs transmission and reception of data, establishment of a communication network, establishment of communication such as voice, provision of a storage area for exchanging data, and the like between the questioner M1, the respondents M2 and M3, and the like.

Note that the groupware tool GR may be a combination of tools for managing a schedule, a tool for making communication, and the like. Accordingly, the groupware tool GR may have a configuration in which a plurality of programs are combined.

In addition, the communication system 1 may use a network as follows, for example.

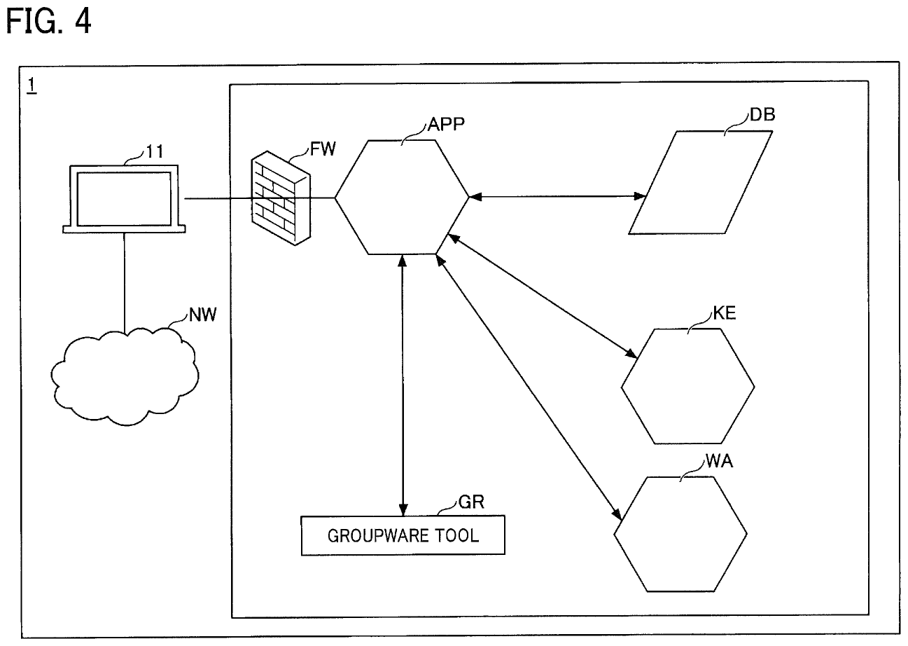

FIG. 4 is a conceptual diagram illustrating an example of a network configuration used by the communication system 1. For example, the communication system 1 has a system configuration as illustrated in FIG. 4. As illustrated, the communication system 1 may have a network configuration in which a virtual private cloud (VPC) is implemented by a firewall FW or the like.

Similarly, the groupware tool GR only needs to be configured to establish communication, and as illustrated in FIG. 4, the communication system 1 may be configured to have a program or data that implements the groupware tool GR. On the other hand, for example, as illustrated in FIG. 3, the communication system 1 may output and use input data from an external groupware tool GR. Alternatively, a configuration in which some or all of the functions and the like cooperate with the groupware tool GR may be used.

The communication system 1 may be configured to perform the keyword extraction process KE or to obtain a keyword extraction result and may be configured to be able to search various databases DBs with keywords or the like.

Using the communication system 1 as described above, for example, the questioner M1 obtains an answer as follows.

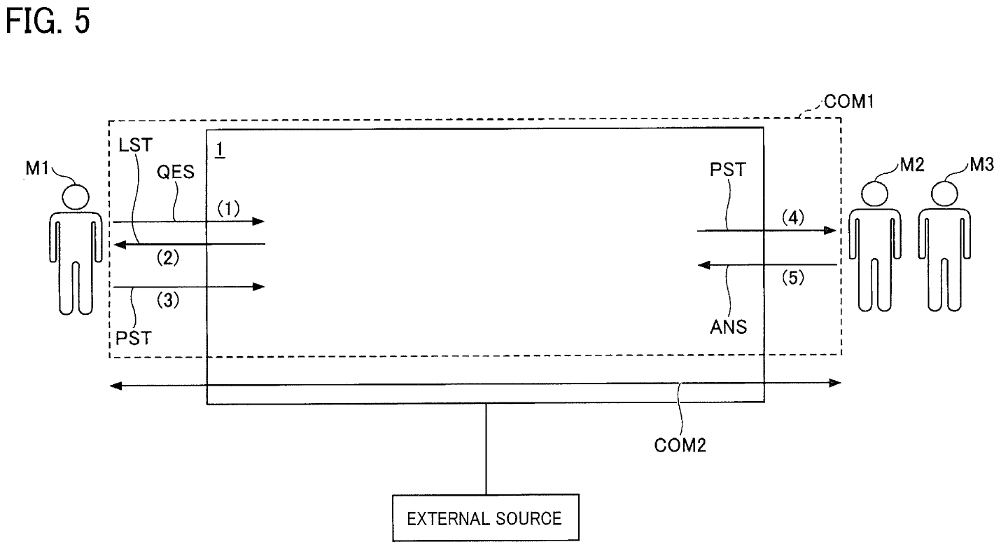

FIG. 5 is a conceptual diagram illustrating an example of a process executed by the communication system 1. First, communication of submitting a question and answering the question (hereinafter referred to as “first communication COM1”) is performed, for example, as follows.

In the first communication COM1, at step (1), the questioner M1 inputs a question QES to the communication system 1. In response to the question QES, at step (2), the communication system 1 first outputs a list LST indicating candidate respondents.

Next, the questioner M1 selects a respondent from the list LST and submits the question QES. At step (3) and (4), text or the like indicating the question QES is transmitted as transmission data PST to the electronic destinations of the respondents M2 and M3. The respondents M2 and M3 know the contents of the question QES by looking at the transmission data PST.

Note that output of the list LST may be omitted. In this case, the questioner M1 may submit the question QES without being aware that the question is sent to the respondents M2 and M3. However, even if the output of the list LST is omitted, the questioner M1 may view the respondents M2 and M3 by outputting the list LST after submitting the question QES.

The electronic destination is, for example, an e-mail address. The transmission data is, for example, e-mail data in which a question or the like is described in text, or text data in which a question or the like is described and attached to the e-mail. The method of transmitting a question is not limited to using e-mail. For example, the transmission data PST may be transmitted by transmitting and receiving a message in an application or the like. In such a case, the electronic destination is an address or identifier (ID) for sending the message.

Subsequently, at step (5), the respondents M2 and M3 input an answer ANS to the question QES. Then, data indicating the answer ANS is transmitted to the electronic destination of the questioner M1. As described above, the questioner M1 obtains the answer ANS to the question QES.

As illustrated in FIG. 5, the communication system 1 may use an external source.

The second communication COM2 is a communication performed in addition to the first communication COM1. Specifically, the second communication COM2 is, for example, an F2F meeting in which the questioner M1 and the respondents M2 and M3 gather in the meeting room, and talk about the question QES and the answer ANS. The communication system 1 makes settings such as reservation of the second communication COM2.

Note that the method of implementing the first communication COM1 is not limited to the above method. In other words, the first communication COM1 is configured such that, when one of the respondents makes an answer ANS to the question QES submitted by the questioner M1, the route to which the answer ANS is sent, the data used for the answer ANS, and the like may be in other methods and formats as long as the answer is transmitted to the questioner M1. Hereinafter, an example of the first communication COM1 in FIG. 5, in which the questioner M1 submits a question QES, the respondents M2 and M3 are searched, and the respondents M2 and M3 sends answer ANS to the questioner M1 by mail is described.

As described above, the communication includes F2F verbal conversation, e-mail, bulletin board, chat, video meeting, telephone, voice communication through a network, data sharing, sharing writing on an electronic whiteboard, or combination of above methods.

The first communication COM1 is an electronic exchange mainly performed between a plurality of persons using electronic communication. On the other hand, the second communication COM2 is a communication method different from the first communication COM1 and is mainly a meeting by F2F. However, a communication device such as a telephone and a video meeting system may be used for the second communication COM2. The setting of the second communication COM2 is to reserve a meeting place such as a meeting room or to input a schedule for the meeting by using groupware or the like.

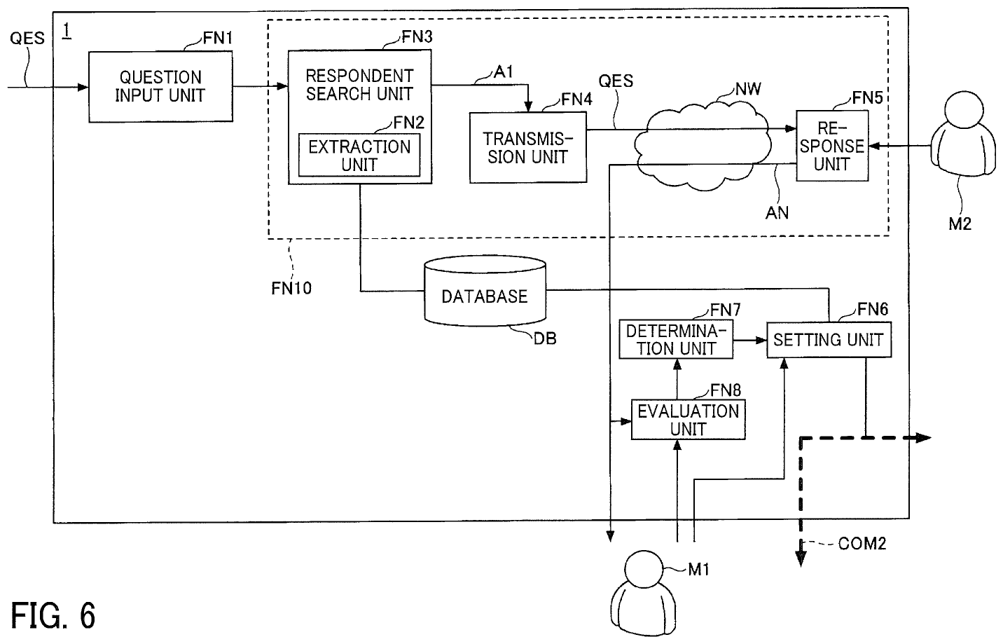

FIG. 6 is a block diagram illustrating an example of a functional configuration of the communication system 1. For example, the communication system 1 has a configuration including a question input unit FN1, a first communication unit FN10, and a setting unit FN6. As illustrated in FIG. 6, the communication system 1 preferably includes a respondent search unit FN3, a transmission unit FN4, and a response unit FN5. Further, it is desirable that the communication system 1 further includes an evaluation unit FN8 and a determination unit FN7. Furthermore, the respondent search unit FN3 may include an extraction unit FN2, as illustrated in FIG. 6. Hereinafter, an example in which the functional configuration is as illustrated in FIG. 6 is described.

The question input unit FN1 executes a question input process for inputting a question QES from a questioner. For example, the question input unit FN1 is implemented by the keyboard 511 or the like.

The extraction unit FN2 executes an extraction process for extracting the keyword KY from the question QES input by the question input unit FN1. For example, the extraction unit FN2 is implemented by the CPU 501 or the like.

The respondent search unit FN3 executes a respondent search process for searching the respondent M2 to answer the question QES. For example, the respondent search unit FN3 is implemented by the CPU 501 or the like.

The transmission unit FN4 executes a transmission process for transmitting the question QES to the respondent. For example, the transmission unit FN4 is implemented by the CPU 501 or the like.

The answering unit FN5 executes an answering process for receiving an answer AN to the question QES from the respondent. For example, the answer unit FN5 is implemented by the keyboard 511 or the like.

The evaluation unit FN8 executes an evaluation process for evaluating the answer AN. For example, the evaluation unit FN8 is implemented by the keyboard 511 or the like.

The determination unit FN7 executes a determination process of determining whether the evaluation of the answer AN by the evaluation unit FN8 satisfies a predetermined condition. The predetermined condition indicates a condition in which an answer AN satisfies requirement of the questioner. The determination unit FN7 is implemented by, for example, the CPU 501 or the like.

The setting unit FN6 executes a setting process for setting the second communication COM2 separately from the first communication. The setting unit FN6 is implemented by, for example, the network I/F 509 or the like.

With the configuration as illustrated in FIG. 6, the second communication COM2 is easily set separately from the first communication. Accordingly, communication between the questioner and the respondent is easily performed.

Further, the communication system 1 includes a database DB storing various information as illustrated in FIG. 6. For example, the database DB stores information as described in the following Table 1 to Table 4. Such information is input to the database DB in advance by a user or obtained from another database or the like and input to the database DB. The respondent search unit FN3 and the setting unit FN6 grasp various settings and the like by searching the database DB.

However, the information does not have to be centrally managed at one place as illustrated in FIG. 6. That is, there may be a plurality of databases DBs, and the information may be distributed and stored.

As illustrated in FIG. 6, when the questioner M1 inputs evaluation such as “best answer”, the setting unit FN6 is notified of the evaluation. When such a notification is made, the setting unit FN6 sets the second communication COM2.

Alternatively, the questioner M1 may input a reference for evaluation of the answer. For example, when the questioner M1 makes an input, the evaluation unit FN8 performs tag extraction and the like to generate an evaluation value based on the input of the questioner M1. Then, the determination unit FN7 extracts a response with a high evaluation based on the evaluation value, that is, an answer corresponding to “best answer”, and notifies the setting unit FN6 of the extraction result. The setting unit FN6 may set the second communication COM2 based on such a notification.

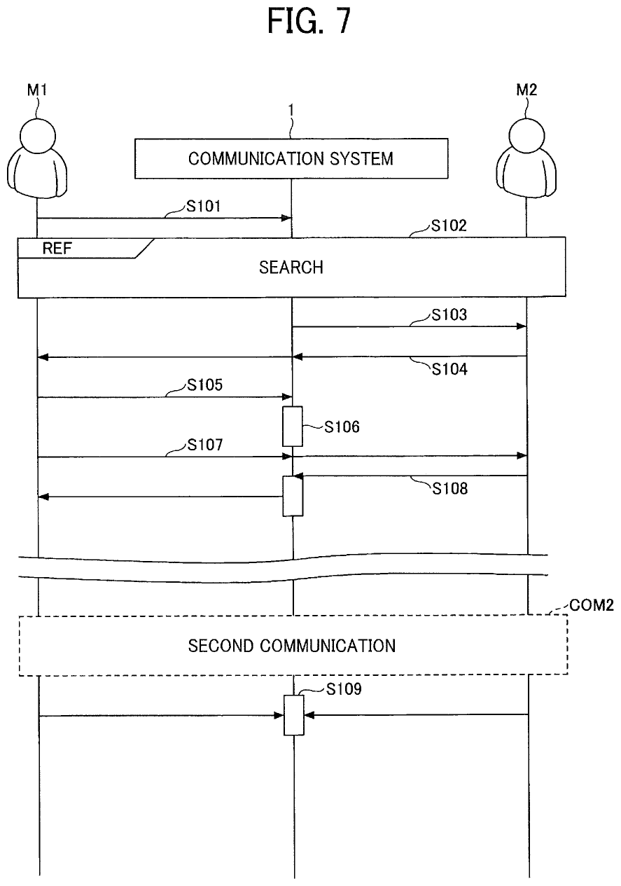

FIG. 7 is a sequence diagram illustrating an example of an overall process executed by the communication system 1. For example, the communication system 1 executes the overall process by the following procedure. In the following description, the communication system 1 is assumed to include a groupware tool GR, for example, as illustrated in FIG. 4.

In step S101, the question input unit FN1 inputs a question QES from the questioner M1. Specifically, the question input unit FN1 receives a text or the like indicating the question QES.

In step S102, the respondent search unit FN3 searches for a respondent.

In step S103, the transmission unit FN4 transmits the question to the electronic destination of the respondent M2.

In step S104, the response unit FN5 receives an answer to the question from the respondent M2 and transmits the answer to the questioner M1.

For example, the following GUI is used in the overall process.

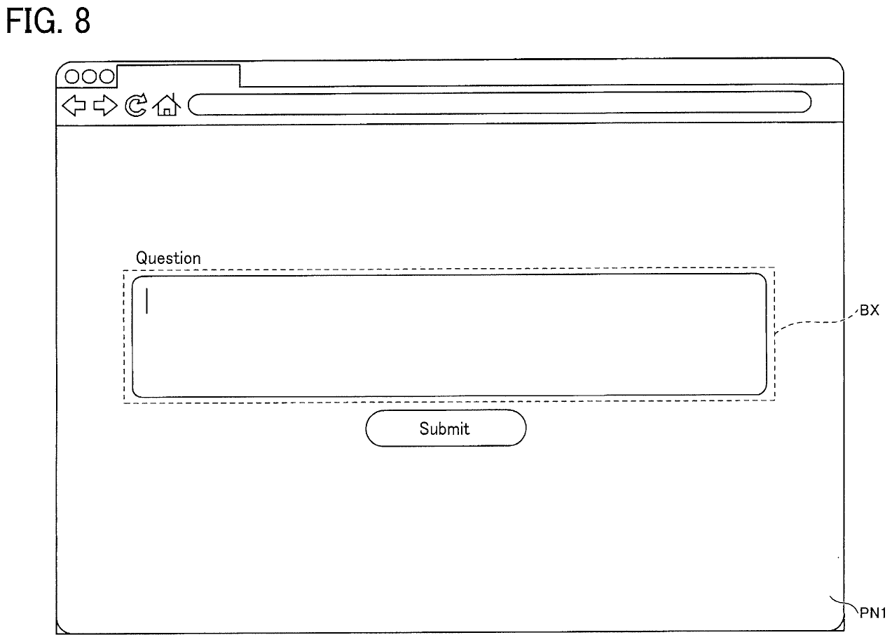

FIG. 8 is a diagram illustrating an example of an input screen for inputting the question. For example, the communication system 1 accepts a question on an input screen PN1 as illustrated in FIG. 8. Specifically, the input screen PN1 has, for example, a text box BX or the like. An operation of inputting a character, a symbol, a numerical value, or the like is accepted in the text box BX. The communication system 1 uses the text box BX to input a sentence as a question using the text box BX or the like. That is, the communication system 1 executes step S101 on the input screen as illustrated in FIG. 8.

Note that the interface for inputting the question need not be a GUI as illustrated in FIG. 8. For example, the question may be input by voice or the like, or an image or the like may be attached. Hereinafter, the GUI illustrated in FIG. 8 is described as an example.

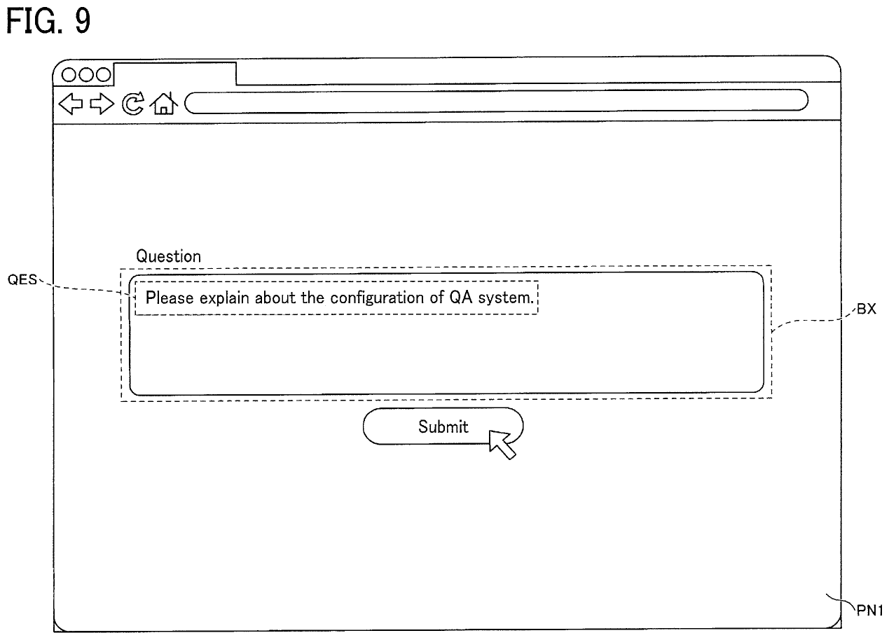

FIG. 9 is a diagram illustrating an example of inputting the question. For example, when the questioner inputs the question QES, the question QES is displayed on the input screen PN1 as illustrated in FIG. 9. Difference from FIG. 8 is that a sentence indicating the question QES has been input in the text box BX. In this example, when the “submit” button is pressed, the process proceeds to the next process, and for example, the following result is displayed.

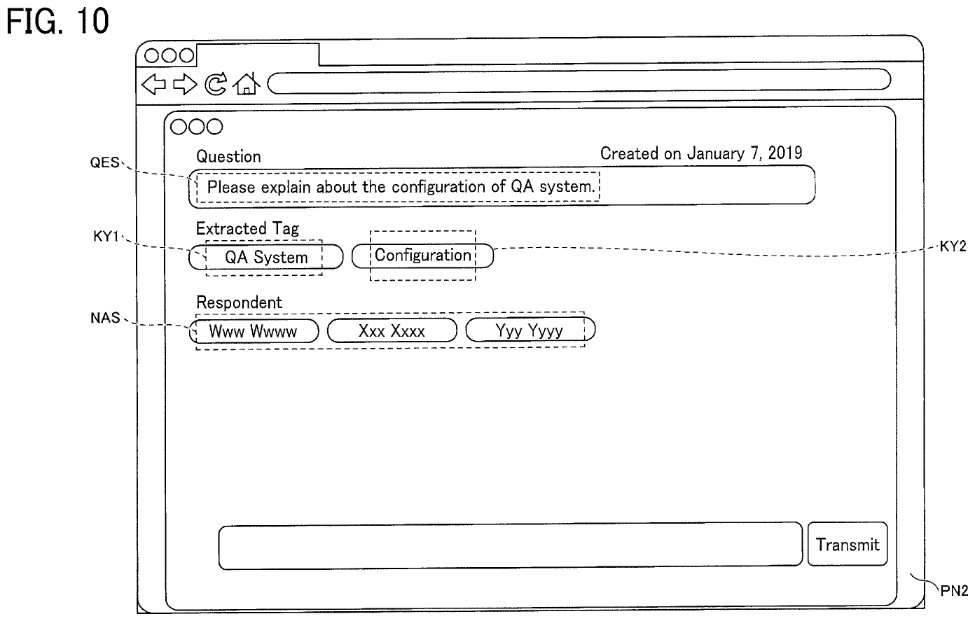

FIG. 10 is a diagram illustrating an example of a keyword extraction result and a search result of the respondent. For example, the selection screen PN2 receives an operation as illustrated in FIG. 10.

First, the selection screen PN2 displays the question QES input on the input screen PN1. Then, a result of extracting the keyword from the question QES is displayed on the selection screen PN2.

The example illustrated in FIG. 10 indicates a result of extracting two keywords, the first keyword KY1 and the second keyword KY2 from the question QES. In the example, the first keyword KY1 and the second keyword KY2 are extracted as “tags”.

The selection screen PN2 displays the result of searching for the respondent NAS that is the transmission destination of the question. The respondent NAS is searched based on, for example, relation to the questioner. Note that the respondent NAS may be searched by another method.

For example, respondent NAS may be searched based on skill. Words indicating respective skill are set in advance to candidate of the respondent. For example, a word indicating a technical field, or a product name is set as the skill. Then, when a keyword is extracted from the question, a candidate who has the same keyword set as the skill is searched. As described above, the respondent NAS may be searched based on self-reported skill set in advance or the like.

An upper limit may be set on the number of respondents. For example, respondents are first ranked based on tags or the like. If the number of respondents is larger than the upper limit number, the respondents may be narrowed down based on the rank assigned to the respondents so that the number of respondents is equal to or less than the upper limit number.

Next, for example, confirmation is performed on the following screen or the like, and the question is transmitted to the respondent.

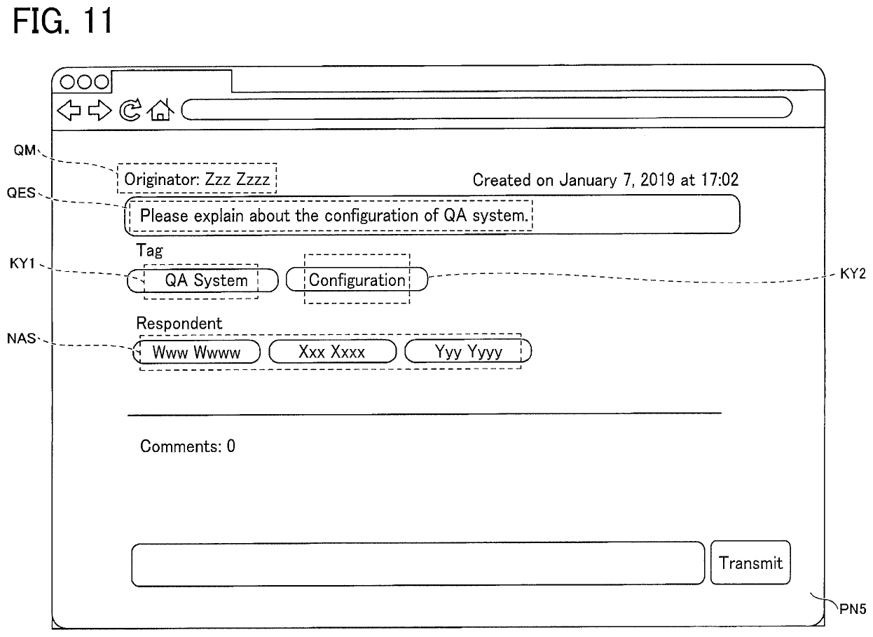

FIG. 11 is a diagram illustrating an example of a transmission screen. For example, the transmission screen PN5 displays the question QES, the first keyword KY1, the second keyword KY2, the respondent NAS, and the like, similar to the selection screen PN2.

For example, as described above, the first communication including submitting a question, searching for a respondent to the question, and answering by the respondent are performed. Next, for example, the second communication is performed as follows.

In step S105, the questioner M1 inputs a request to conduct an F2F meeting with the respondent M2. The request may be input by the respondent M2.

In step S106, the setting unit FN6 reserves resources for performing the second communication. For example, the setting unit FN6 reserves a place for meeting or equipment to be used for the second communication. Specifically, in the case of F2F meeting, a meeting room or an empty space is used as the meeting place, and a reservation is made according to a meeting schedule or the like. Note that the resources may not be explicitly reserved as described above. For example, the second communication may be immediately performed according to a request. A chat or a video meeting may be started immediately. Even in such a case, resources such as the communication devices need to be reserved.

The reservation may include a schedule, equipment, or both. For example, the setting unit FN6 acquires data indicating the schedules of the questioner M1 and the respondent M2 and finds a time slot in which both questioner M1 and respondent M2 are free.

In addition, it is desirable that the setting unit FN6 finds out whether location and facility are available in addition to the schedule of the questioner M1 and the respondent M2. That is, it is desirable that the setting unit FN6 extracts an empty meeting room and facilities that can be used while schedules of the questioner M1 and the respondent M2 are free.

As described above, the communication system 1 reserves resources and the like used in the second communication such as places and facilities according to the schedule. Reserving resources collectively as described above reduces effort.

In step S107, the questioner M1 inputs a desired date, for example, based on the adjusted schedule or the like, and then requests the respondent M2 for an F2F meeting through the communication system 1. Note that the communication system 1 may receive a request from the questioner M1 if there is a request for the type, date, facility, location, and the like of the second communication COM2.

In step S108, the communication system 1 accepts a reply to the request for the meeting from the respondent M2. Then, if the reply from the respondent M2 is positive, the communication system 1 sets a schedule for the questioner M1 and the respondent M2. When the location and the equipment are decided, the communication system 1 may reserve a location and equipment based on the decided schedule.

The communication system 1 may send a meeting notice to the questioner M1 and the respondent M2 indicating the date and time, place, equipment, and the like at which the second communication COM 2 is set.

After the second communication COM2, the communication system may receive a result of the second communication COM2.

In step S109, the communication system 1 causes the questioner M1, the respondent M2, and the like to input the result of the F2F meeting such as an image of writing on a whiteboard, minutes of the meeting, and any other information. It is desirable that the communication system 1 accumulates the result of such communication.

It is desirable that the input information is used for feedback or the like. The communication system 1 may display the result of the meeting in the form of minutes or the like. In addition, the communication system 1 may create a summary or the like for feedback of the input information.

The feedback may be a display for confirming whether or not a result has been input, or a display for allowing selection of the input result.

A second example of the overall process may be a process such as described below.

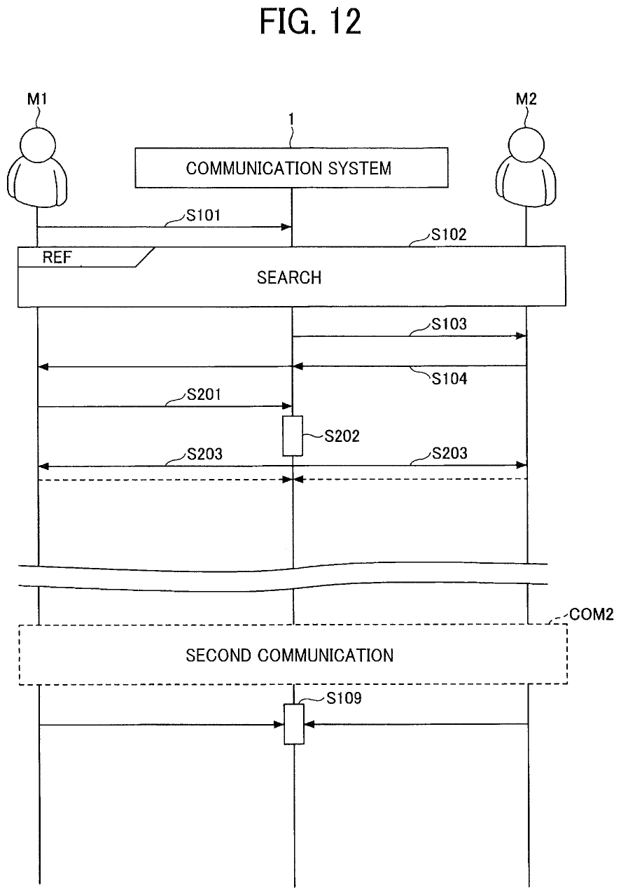

FIG. 12 is a sequence diagram illustrating a second example of the overall process executed by the communication system 1. The second example differs from the first example in the type of the second communication COM2. In the second example, the type of the second communication COM2 is, for example, chat. Hereinafter, the same processes as those in the first example are denoted by the same reference numerals, and description thereof is omitted.

In step S201, the questioner M1 inputs a request for additionally performing chat communication with the respondent M2. The request may be input by the respondent M2.

In step S202, the setting unit FN6 generates a chat channel.

In step S203, the setting unit FN6 invites the questioner M1 and the respondent M2 to the generated channel. When the questioner M1 and the respondent M2 accept the invitation, the questioner M1 and the respondent M2 participate in the chat and the questioner M1 and the respondent M2 communicate with each other as the second communication COM2.

When generating and inviting the questioner M1 and the respondent M2 to the channel, it is desirable that the setting unit FN6 refers to the schedule of the questioner M1 and the respondent M2 to determine whether chat is possible.

Further, after the second communication COM2, the communication system 1 desirably accumulates the communication results, as in the first example. Specifically, when the consent is received for storing the communication record, the communication system 1 may accumulate chat data, channel logs, and the like as the communication result.

It is desirable that the stored records and the like is fed back. The communication system 1 may display the record in a format such as minutes. In addition, the communication system 1 may create a summary or the like to feedback the input information.

In addition, the feedback may be a display for confirming the presence or absence of a record, a display for selecting a record, or the like.

A third example of the overall process may be a process such as described below.

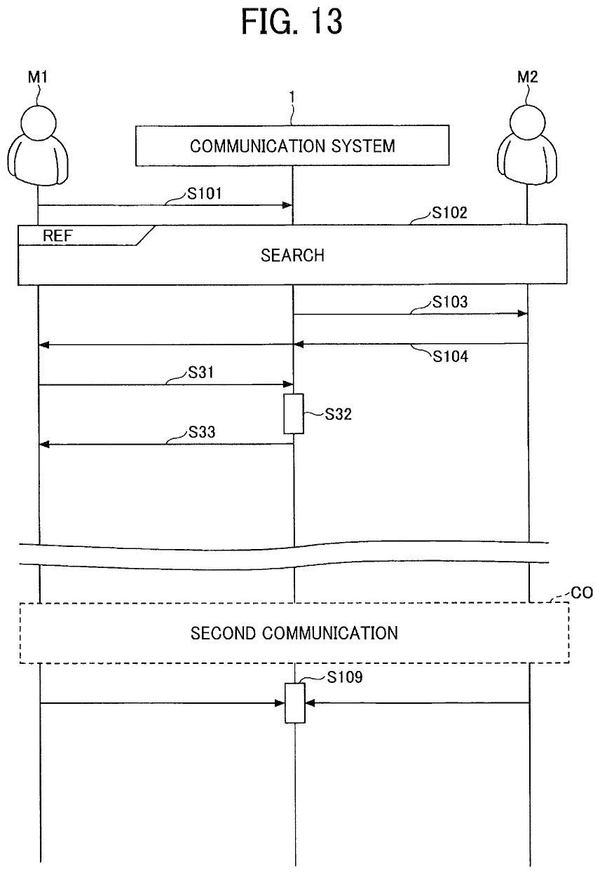

FIG. 13 is a sequence diagram illustrating a third example of the overall process executed by the communication system 1. The third example differs from the first example in the type of the second communication COM2. In the third example, the type of the second communication COM2 is, for example, a telephone. Hereinafter, the same processes as those in the first example are denoted by the same reference numerals, and description thereof is omitted.

In step S31, the questioner M1 requests the communication system 1 for communication with the respondent M2 by telephone. The request may be input by the respondent M2.

In step S32, the setting unit FN6 searches the telephone number of the respondent M2 from the database or the like.

In step S33, the setting unit FN6 displays the telephone number of the respondent M2 to the questioner M1. The setting unit FN6 refers to the schedule of the respondent M2, and when the respondent M2 is absent or the like, it is desirable to display “absence” or the like to the questioner M1. With such a display, the questioner M1 can reduce unnecessary work.

In addition, when the respondent M2 is out, the communication system 1 may display the telephone number of the external line. On the other hand, when the respondent M2 is in the office, the telephone number of the extension may be displayed.

The questioner M1 and the respondent M2 perform the second communication COM2 by calling using the obtained telephone number.

Further, after the second communication COM2, the communication system 1 desirably accumulates the communication results, as in the first example. In the third example, the communication system 1 may accumulate a log indicating a call record or the like as a communication result. In particular, if the telephone is Skype (registered trademark) or the like that makes a call through a personal computer (PC), the communication system 1 refers to and accumulates the data.

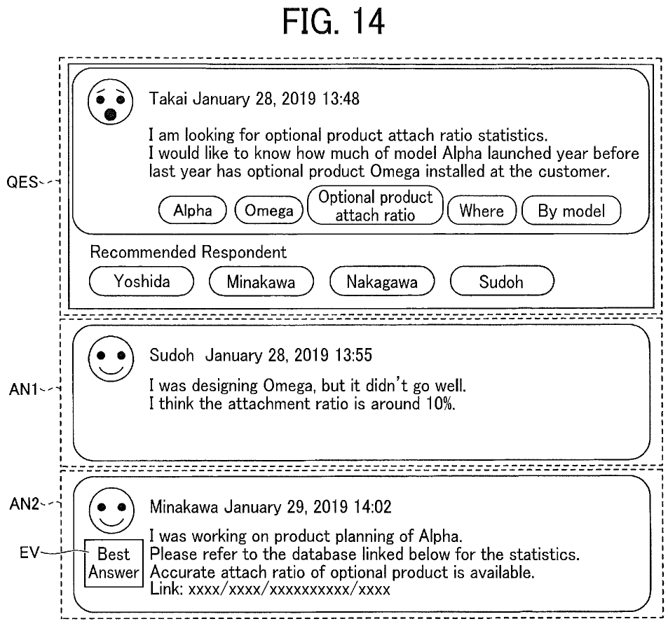

FIG. 14 is a diagram illustrating a screen of a comparative example. For example, as illustrated in FIG. 14, a questioner inputs a question QES in the communication system 1.

As illustrated in FIG. 14, the respondents make a first answer AN1 and a second answer AN2 to the question QES.

As illustrated in FIG. 14, the questioner may input an evaluation EV to the answer, such as “Best Answer” to the most useful answer among the first answer AN1 and the second answer AN2. When a communication system 1 is used for such a screen, for example, the following GUI is displayed.

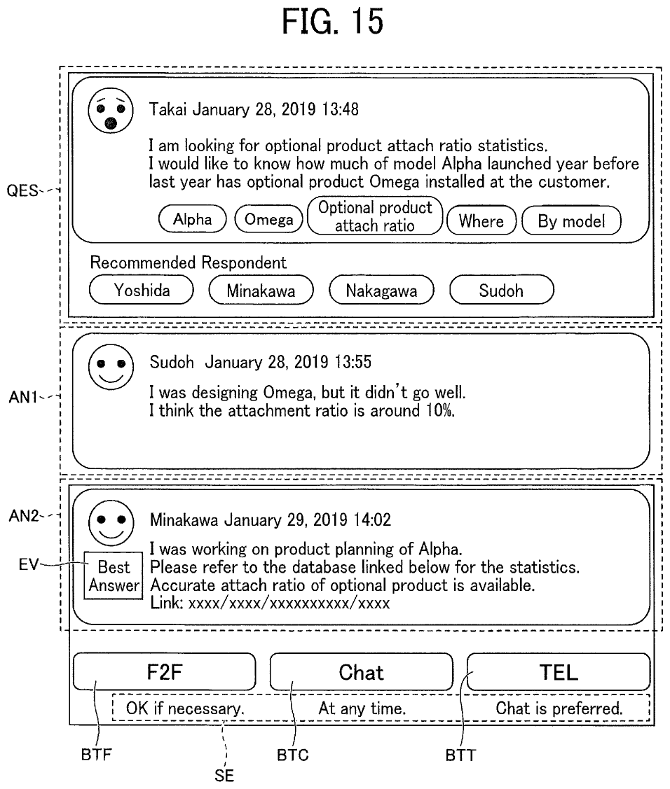

FIG. 15 is a diagram illustrating an example of a screen including a GUI for setting the second communication COM2. The screen illustrated in FIG. 15 differs from the screen illustrated in FIG. 14 in that a button and a display for the second communication COM2 are added. Hereinafter, a case where type of the second communication COM2 is selected from “F2F”, “Chat”, and “TEL” is described as an example. Note that the type of the second communication COM2 is not limited to three. The type of the second communication COM2 is not limited to the F2F meeting, the chat, and the telephone as in the following example, and another type may be set.

The type of the second communication COM2 is set by the setting unit FN6. The respondent sets in advance by the setting unit FN6, the type and time of the second communication COM2 that can be executed. The information set as described above is displayed as illustrated in FIG. 15.

In the following description, the case where the questioner requests the second communication with the respondent is described as an example, but the following operation may be performed by another person wishing to add the second communication. Specifically, it is desirable that the setting unit FN6 sets up the second communication with the respondent for the questioner when the “Best Answer” is entered as the evaluation.

The input of the “Best Answer” as the evaluation is an example of the predetermined condition, and the input of “Best Answer” is an example of the case where the predetermined condition is satisfied. In addition, criteria for determining whether a predetermined condition is satisfied, and the GUI used for evaluation are not necessary to use the predetermined conditions, criteria, and GUI as illustrated in the figure, and the user or the like may be able to set the conditions.

In the example illustrated in FIG. 15, the F2F button BTF is a button for selecting an F2F meeting. In step S105, any one of the F2F button BTF, the Chat button BTC, and the TEL button BTT is pressed to request an F2F meeting. For example, when the F2F button BTF is pressed, the following screen is displayed.

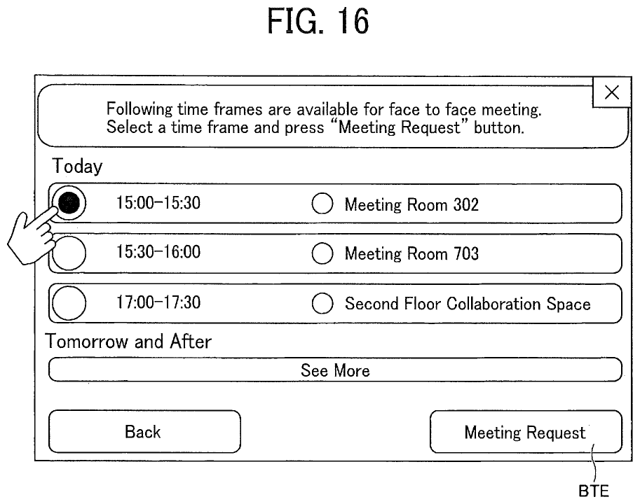

FIG. 16 is a diagram illustrating an example of a screen including a GUI for setting the F2F meeting. In the example illustrated in FIG. 16, the communication system 1 accepts a request for a date and a place where the F2F meeting is to be held.

In step S106, the communication system 1 extracts, for example, a time slot in which both the schedule of the questioner and the schedule of the meeting room are free and displays a list of dates and places where a meeting is likely to be held as illustrated in FIG. 16. Then, the questioner selects a preferable date or the like from the list as illustrated in FIG. 16. The list to be displayed may be output for a plurality of days, for example, within one week.

In step S107, when the Meeting Request button BTE is pressed, the selected date and the like are notified to the questioner by e-mail or the like.

It is desirable that a date and time when the meeting can be held, an upper limit time for the second communication, a comment, or a combination thereof can be input to the communication system 1 in advance. In particular, it is desirable that the F2F meeting can be designated so that the longest time of the second communication is about 15 to 30 minutes. If the longest time is about 15 minutes to 30 minutes, it is possible to prevent burden from increasing, and easy communication is facilitated.

When the Chat button BTC is pressed in step S201, the communication system 1 sets a chat by connecting the questioner and the respondent in step S202 and step S203.

In step S31, when the TEL button BTT is pressed, the communication system 1 searches and displays a telephone number in step S32 and step S33.

Further, it is desirable that a message SE or the like can be set. In the example illustrated in FIG. 15, the message SE indicates the type of the desired second communication. Note that the message SE may include a comment, a date and time at which communication is possible, an upper limit time, or a combination thereof. When the message SE or the like is set as described above, a preferable method or preferable date and time for communication is understood with ease.

It is desirable that the communication system 1 calculate the evaluation value of the respondent or the questioner based on the result of the second communication COM2. For example, when the respondent accepted a request for an F2F meeting from the questioner, the communication system 1 adds the evaluation value to the respondent. If the second communication is performed the communication system 1 may add the evaluation value to the questioner and the respondent considering that the communication is activated. The communication system 1 activates communication in this way.

Further, in order to prevent a situation such as cancellation of reservation without notice, the communication system 1 may calculate an evaluation value based on the result of the second communication COM2.

As described above, the evaluation unit FN8 first receives the evaluation of the answer from the questioner. The evaluation may be selecting the “Best Answer” from the multiple answers as described above, or an evaluation value from a preset stage may be selected for each answer. When the evaluation unit FN8 receives the evaluation, the determination unit FN7 determines an excellent answer or the like based on the input evaluation by comparing the evaluation with the predetermined condition set in advance. Then, the setting unit FN6 sets the second communication, for example, as illustrated in FIG. 15, for the answer evaluated to satisfy the predetermined condition.

The communication system 1 stores the following information according to, for example, settings made in advance.

TABLE 1

| Basic Information | | Second Communication | | |
|---|---|---|---|---|
| | Tag | TEL | Chat | F2F |
| User ID | Information | Availability | Availability | Availability |
| U1001 | Software | No | Yes | Yes |
| | Development | (Comment) | (Comment) | (Comment) |
| | Python | Chat is | First Priority | Second |
| | Language | preferred. | | Priority |
| | IoT | | | |
| | Architecture | | | |
| | UX Design | | | |

For example, information stored in Table 1 is used for the search and the second communication COM2.

“User ID” is information for identifying a user. For example, “User ID” is information to be input for login.

“Tag Information” is information on qualifications and skills possessed by the user associated with the user ID. The “Tag Information” may be acquired from user management information (information stored in Table 2 below) or the like. For example, career of the user is input in the “Tag Information”.

In the “Second Communication”, information on whether or not the user can accept each type of the second communication COM2 is stored. Hereinafter, an example where the types of the second communication COM2 are “TEL”, “Chat”, and “F2F” is described.

In “TEL Availability”, availability of communication by telephone call is input. As described in the table, when “No” is input, a setting is made to reject communication by telephone.

In “Chat Availability”, availability of chat communication is input. As described in the table, when “Yes” is input, a setting is made to accept communication by chat.

In “F2F Availability”, availability of communication such as by an F2F meeting is input. As described in the table, when “Yes” is input, the setting is made to accept communication by the F2F meeting.

Priorities may be further set as described in the table for “Chat Availability” and “F2F Availability”. Also, a comment may be set as described in the table.

Based on information stored in Table 1, for example, the communication system 1 displays a screen as illustrated in FIG. 15.

TABLE 2
User Management Information

| User ID | User Information | Skill and Qualification |
|---|---|---|
| U1001 | Name | Software Development |
| | Affiliation | Python Language |
| | Superior | IoT Architecture |
| | Mail Address | UX Design |
| | Telephone | Embedded |
| | Number | Software Development |
| | (Extension/External) | UML |
| | | C Language |
| | | C# Language |

For example, information stored in Table 2 is used for the search and the setting of the second communication COM2.

“User ID” is the same as in the Table 1 and identifies a user.

“User Information” is, for example, information on the user such as an affiliation and a superior. Further, for example, a contact address such as a mail address and a telephone number is stored in the “User Information”.

As “Skill and Qualification”, a career of the user, qualifications held, and the like are included.

Based on information stored in Table 2 above, the communication system 1 displays contact information by e-mail or telephone, for example.

TABLE 3
Communication Settings

| | | External System |
|---|---|---|
| User ID | Chat Settings | Cooperation |
| U1001 | Nick Name: XXX | Notify when xxxx |
| | Language: Japanese | Notify when yyyy |
| | Notification Message: xxx | |

Based on information stored in Table 3, for example, a second communication COM2 by chat is set.

“User ID” is the same as in the Table 1 and identifies a user.

In “Chat Settings”, a nickname displayed on the chat, language used for the chat, content of a message to be notified, and the like are included.

“External System Cooperation” is settings used to cooperate with an external tool. For example, as described above, conditions for notifying the user are set.

Based on the information stored in Table 3, the communication system 1 sets communication by chat, for example.

TABLE 4
Resources Reservation

| Office | Meeting Room | Reservation |
|---|---|---|
| XX | Meeting | March 11, 2019 |
| Office | Room AA | 09:00-10:00 Design Review |
| YY | Meeting | March 11, 2019 |
| Office | Room BB | 10:00-11:00 Vacant |

For example, information stored in Table 4 is used for setting the second communication COM2 by chat.

“Office” is an example of information indicating a place where a meeting room is located.

“Meeting Room” is information indicating a place or facility, such as the name of a meeting room. The “Meeting Room” may include information such as capacity and available equipment.

“Reservation” is information indicating reservation made for each meeting room. “Reservation” indicates schedules of a place and equipment. Based on “Reservation”, the communication system knows, for example, a date and time when the second communication COM2 is possible. The communication system, based on such information, checks the time slot where the meeting room and the facilities are vacant, presents and reserves a candidate date.

Note that a range of disclosure and transmission of information such as a question may be limited. The contents of the question may include a trade secret information. In order to keep the information confidential to outside party, the range of disclosure of the information may be limited to inside the company or the candidates of the respondents may be limited to persons in the company.

Each device need not be a single device. That is, each device may be a combination of a plurality of devices. Note that the configuration may further include devices other than those illustrated.

The information processing apparatus may be an image forming apparatus or the like as long as the apparatus includes a communication function. The information processing apparatus includes, for example, an output device such as a projector (PJ), an interactive white board (a white board having an electronic whiteboard function capable of mutual communication (MB)), a digital signage, a head up display (HUD) device, and an industrial machine, an imaging device, a sound collecting device, a medical device, a network home appliance, an automobile (connected car), a notebook PC, a mobile phone, a smartphone, a tablet terminal, a game console, a personal digital assistant (PDA), a digital camera, a wearable PC or a desktop PC.

The communication system 1 may use artificial intelligence or the like. The communication system 1 may use machine learning or the like for processing such as searching for similar questions, extracting keywords, or adding respondents. For example, a method of extracting a selected question may be learned using the result of selecting question from similar questions as learning data. As described above, the communication system 1 may perform processing based on the result of learning each processing.

All or a part of each process according to the present disclosure may be described in a low-level language or a high-level language and may be implemented by a program for causing a computer to execute a communication method. That is, the program is a computer program for causing a computer such as a communication system to execute each process.

When the communication method is executed based on the program, the arithmetic device and the control device included in the computer perform the calculation and control based on the program in order to execute each process. The storage device of the computer stores data used for processing based on the program in order to execute each processing.

Further, the program can be recorded on a computer-readable recording medium and distributed. Note that the recording medium is a medium such as a magnetic tape, a flash memory, an optical disk, a magneto-optical disk, or a magnetic disk. Further, the program may be distributed through a telecommunication line.

The embodiment according to the present disclosure may be implemented by a communication system having a plurality of information processing apparatuses. Further, the communication system may execute each process and storage of data in a redundant, distributed, parallel, virtual or a combination thereof.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

What is claimed is:

1. A communication system comprising:
a memory that stores a plurality of instructions; and
a processor that executes the plurality of instructions, configured to:
input a question received from a questioner;
search for a respondent to the question;
perform a first communication to answer the question; and
set a second communication separately from the first communication.

2. The communication system of claim 1, wherein
the processor is further configured to:
evaluate the answer;
determine whether evaluation satisfies a predetermined condition; and
set the second communication when the evaluation satisfies the predetermined condition.

3. The communication system of claim 1, wherein the processor is further configured to make a reservation of resources for performing the second communication.

4. The communication system of claim 1, wherein the reservation of resources includes a reservation for any one of schedule, equipment, and both for performing the second communication.

5. The communication system of claim 1, wherein the processor is further configured to enter a result of the second communication.

6. The communication system of claim 5, wherein the processor is further configured to feedback the result of the second communication.

7. The communication system of claim 1, wherein the processor is further configured to perform the second communication that connects the questioner and the respondent by chat.

8. The communication system of claim 7, wherein the processor is further configured to display on a display a date and time when the second communication is possible.

9. The communication system of claim 7, wherein
the processor is further configured to:
accept consent to keep a record of the second communication; and
keep the record of the chat when the consent is obtained.

10. The communication system of claim 9, wherein the processor is further configured to feedback the record.

11. The communication system of claim 1, wherein the processor is further configured to display contact information to be used for the second communication.

12. The communication system of claim 1, wherein the processor is further configured to designate any one or any combination of the type of the second communication, the date and time when the second communication is possible, an upper limit time of the second communication, and a comment.

13. The communication system of claim 1, wherein the processor is further configured to calculate evaluation value of the respondent and the questioner based on whether the second communication was performed or not and based on the result of the second communication when the second communication is performed.

14. A communication method executed by one or more processors comprising:
inputting a question received from a questioner;
searching for a respondent to the question;
performing a first communication for answering the question; and
setting a second communication separately from the first communication.

15. A non-transitory recording medium storing a plurality of instructions which, when executed by one or more processors, cause the processors to perform a communication method comprising:
inputting a question received from a questioner;
searching for a respondent to the question;
performing a first communication for answering the question; and
setting a second communication separately from the first communication.
